(19) United States
(12) Patent Application Publication
(10) Pub. No.: US 2016/0110936 A1
(43) Pub. Date: Apr. 21, 2016

(54) METHOD OF MAKING TUNING MAP FOR CONTROLLING DEVICE OF VEHICLE

(71) Applicants: HYUNDAI MOTOR COMPANY, Seoul (KR); KIA MOTORS CORPORATION, Seoul (KR)

(72) Inventors: Jung Eun CHO, Incheon (KR); Min Jung KIM, Seongnam-si (KR); Tae Soo CHI, Seongnam-si (KR); Young Eun KO, Gunpo-si (KR); Chan Jung KIM, Seoul (KR)

(21) Appl. No.: 14/863,321

(22) Filed: Sep. 23, 2015

(30) Foreign Application Priority Data
Oct. 21, 2014 (KR) 10-2014-0142473

(51) Int. Cl. G07C 5/08; G07C 5/02

(52) U.S. Cl. CPC G07C 5/0808; G07C 5/02; G07C 5/0841

(57) ABSTRACT

A method of making a tuning map for a vehicle device includes deriving performance parameters of the vehicle device in a new vehicle and setting a target tuning performance. A pre-tuning map is established by building an interpretation model of the new vehicle including an interpretation model and a control model of the vehicle device, and tuning parameters, which satisfy the target tuning performance, are set using the performance parameters through interpretation of the models. The pre-tuning map is applied to a control logic of the vehicle device for an actual vehicle which includes the vehicle device mounted therein, and the actual vehicle tuning is performed. Whether actual vehicle performance satisfy a preset target performance after tuning the actual vehicle is evaluated, and the tuning map is finalized when the target tuning performance is satisfied.

### CROSS-REFERENCE TO RELATED APPLICATION

This application claims under 35 U. S. C. §119(a) the benefit of priority to Korean Patent Application No. 10-2014-0142473 filed on Oct. 21, 2014, the entire content of which is incorporated herein by reference.

### TECHNICAL FIELD

The present disclosure relates to a method of making a tuning map. More particularly, the present disclosure relates to a method of making a tuning map, for example, a motor driven power steering (MDPS) tuning map, for controlling electronic devices in a vehicle to provide a verified pre-tuning map before assembling the vehicle.

### BACKGROUND

A vehicle includes a number of electronic parts and devices such as an engine and a transmission, a steering device, a braking device, etc. for convenient and safe driving.

As the electronics industry has been remarkably developed in recent years, a number of electronic devices are mounted in the vehicle, such as a motor driven power steering (MDPS) for assisting a steering power using a rotating torque of an electric motor.

The motor of the MDPS is controlled to determine an MDPS torque using a steering input value according to manipulation of a steering wheel by a driver based on a tuning map reflected to a control logic, and the MDPS torque determined by the tuning map is outputted.

Referring to FIGS. 1A and 1B, hardware for a new vehicle is developed by establishing a target performance (S1), manufacturing and evaluating a prototype product (S2), preparing and reporting a report (S3), and testing the vehicle (S4).

In other words, the new vehicle has to satisfy the target performance (S1). A prototype is evaluated to check its performance and to check whether the prototype satisfies the target performance after manufacturing electronic devices or parts (S2). The evaluation test report is provided during evaluation of the new vehicle (S3). The parts or the devices are then mounted to the new vehicle to evaluate whether they satisfy the target performance based on the evaluation report (S4).

If the performance of the parts or the devices is satisfied during the vehicle evaluation, specifications thereof are finalized. If not, the process (S1 to S4) repeats until the corresponding parts or devices satisfy the target performance to finalize the specifications.

However, software for controlling an electronic device for a vehicle such as the MDPS does not have a process for developing parts or devices for a new vehicle.

Referring to FIGS. 1A and 1B, a tuning map of a vehicle for mass production is applied as a pre-tuning map contained in the software when developing a new vehicle according to the conventional art. A tuning process for the actual vehicle is carried out to apply the tuning map for the mass production to the software in which a control logic of the part or the device as the pre-tuning map is modified.

When tuning the actual vehicle, whether the tuning map satisfies the performance (for example, steering performance) and the vehicle performance as the target performance is evaluated, and a tuning parameter is repeatedly modified to satisfy the vehicle performance. Then, a tuning map for the new vehicle is finalized for the mass production.

However, when the tuning map set for the mass production is applied to the pre-tuning map for the new vehicle, there are several problems as follows:

First, there are many differences between the existing vehicle and the new vehicle for the mass production due to new features added to the new vehicle. When the tuning map is set with respect to the existing vehicle for the mass production under a condition in which there is a difference between the new vehicle and the existing vehicle for the mass production, it is impossible to evaluate the new vehicle based on the existing vehicle for steering feeling in the MDPS and the like, since the pre-tuning map may not be suitable for the new vehicle.

Thus, the process of modifying the tuning map (re-tuning) to satisfy the target performance cannot repeat during the actual vehicle tuning process, and an optimal tuning map may not be achieved.

In addition, referring to FIG. 2, the target performance may not be achieved and even after repeating tuning for an actual vehicle, since the tuning map for the existing vehicle may not have comparable system properties of the new vehicle and an initial performance (performance when the tuning map of the vehicle for the mass production is applied) may not be good when the tuning map of the vehicle for the mass production.

Moreover, the conventional tuning process highly relies on an operator to achieve the optimal tuning satisfying the target performance.

### SUMMARY OF THE DISCLOSURE

The present disclosure has been made in an effort to solve the above-mentioned problems. An aspect of the present inventive concept provides a method of making a tuning map used in a control logic of software for controlling electronic devices in the development a vehicle such that a verified pre-tuning map, which satisfies a target performance, is provided before the vehicle is assembled, in which performance thereof may be estimated by reflecting properties of the vehicle, and test performance and actual performance may be achieved as the target performance.

Another aspect of the present inventive concept provides a target performance of a device and a vehicle in advance and to contribute overall performance of the vehicle by systemizing a tuning process of designing and evaluating.

In accordance with an embodiment of the present inventive concept, a method of making a tuning map includes deriving performance parameters of the vehicle device for a new vehicle and setting a target tuning performance. A pre-tuning map is established by building an interpretation model of the new vehicle including an interpretation model and a control model of the vehicle device, tuning parameters satisfying the target performance of inputted parameters are set through interpretation of the models. The pre-tuning map is applied to a control logic of the vehicle device for an actual vehicle which includes the vehicle device mounted therein, and an actual vehicle tuning is performed. Whether actual vehicle performance satisfies a preset target performance after tuning the actual vehicle is evaluated, and the tuning map is finalized when the preset target tuning performance is satisfied.

The method of making a tuning map according to the present disclosure has the following advantages:

1) a verified pre-tuning map satisfying target performance may be provided before manufacturing of a vehicle (before actual installation to the vehicle) in which performance may be estimated by reflecting properties of the new vehicle and an optimal tuning map for the mass production may be provided;

2) since an actual tuning is performed by applying the pre-tuning map optimized to the new vehicle, a tuning process is simplified during the actual vehicle tuning, the final tuning map may be made only by a simple fine tuning during the earl vehicle tuning, and a preset quality of tuning may be guaranteed regardless of capability of a person in charge of the tuning;

3) the target performance of the device for the actual vehicle may be early achieved by systemizing the tuning process of designing and evaluating and overall enhancement of performance of the vehicle may be contributed;

4) since the optimization of the tuning map and quantitative interpretation of the actual vehicle performance may be confirmed at the same time, human error occurring when subjective evaluation is carried out may be minimized; and

5) since it is possible to apply to the making of a tuning map of controllers of various control systems that are now applied to vehicles such as not only the MDPS but electronic stability control (ESC) and electronic control suspension (ECS), development of a new vehicle may be maximized and schedule for development of the new vehicle may be reduced.

### BRIEF DESCRIPTION OF THE DRAWINGS

The above and other features of the present disclosure will now be described in detail with reference to exemplary embodiments thereof illustrated the accompanying drawings which are given hereinbelow by way of illustration only, and thus are not limitative of the present disclosure.

FIGS. 1A and 1B are a flowchart showing an existing tuning map developing process of hardware and software.

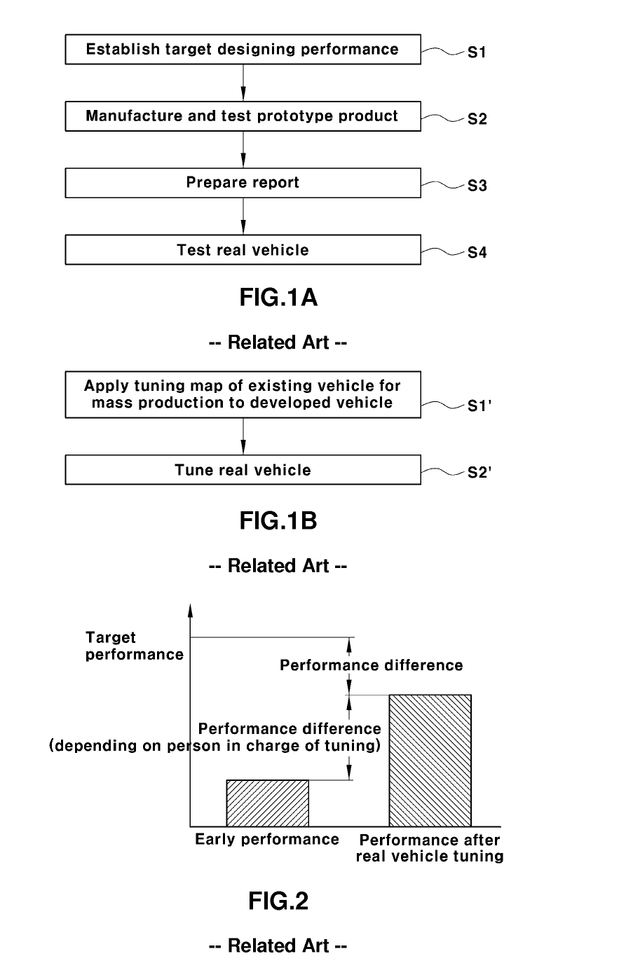

FIG. 2 is a view showing a problem of the existing tuning map developing process.

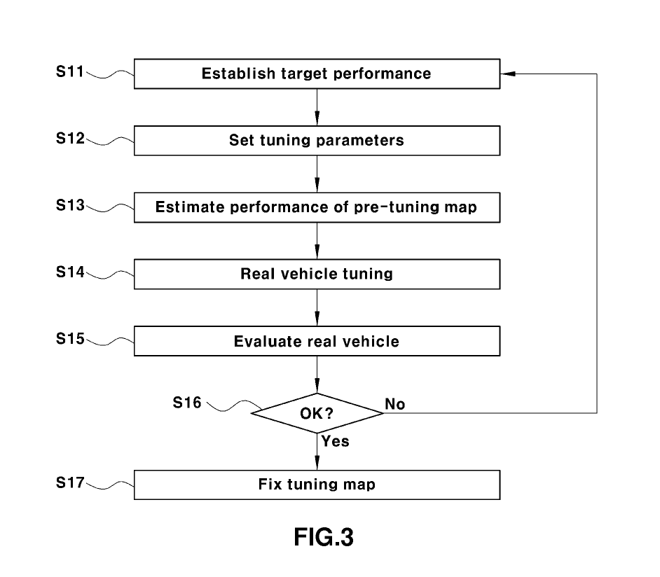

FIG. 3 is a flowchart showing a process of making a tuning map according to an embodiment of the present inventive concept.

FIG. 4 is a view showing a process of making an MDPS tuning map as an embodiment of the present inventive concept.

FIGS. 5A and 5B are views showing a performance parameter of the MDPS in the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, the present disclosure will be described in detail so that those skilled in the art to which the present disclosure pertains can easily carry out the present disclosure.

The present disclosure provides a method of making a tuning map used in a control logic of software for controlling electronic devices for the development a new vehicle. The method provides a verified pre-tuning map satisfying target performance before manufacturing the vehicle (before actual installation to the vehicle) in which performance is estimated by reflecting properties of the new vehicle to achieve test performance and actual performance as the target performance.

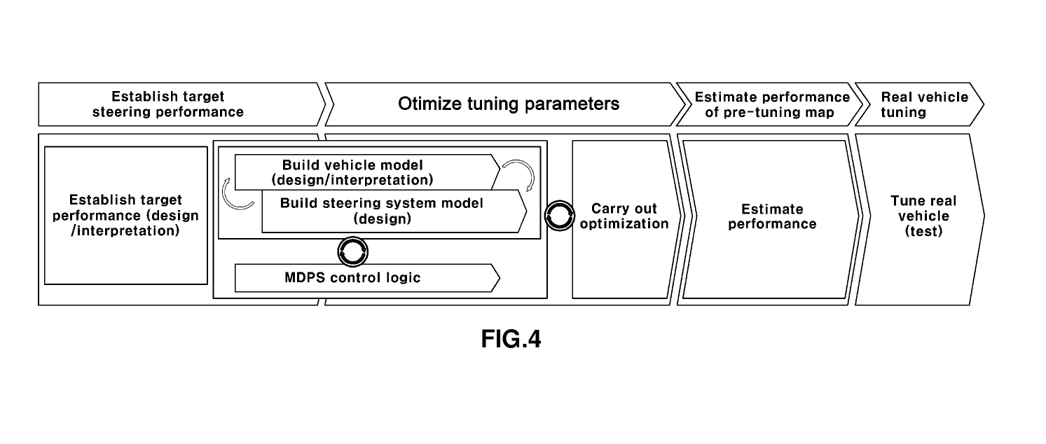

FIG. 3 is a flowchart showing a process of making a tuning map according to an embodiment of the present inventive concept. As shown, a method of making a tuning map according to an embodiment of the present inventive concept includes establishing a target performance (S11), setting a tuning parameter (S12), estimating performance of a pre-tuning map (S13), performing an actual vehicle tuning (S14), evaluating an actual vehicle performance (S15), and fixing a tuning map (S17).

In step S11, performance parameters, which have an influence on performance of an electronic device to be mounted in a new vehicle, are derived, and a target tuning performance on each performance parameter is set by evaluating performance of a competing vehicle and corresponding devices (such as an MDPS) and evaluation results thereof (analysis of the competing vehicle).

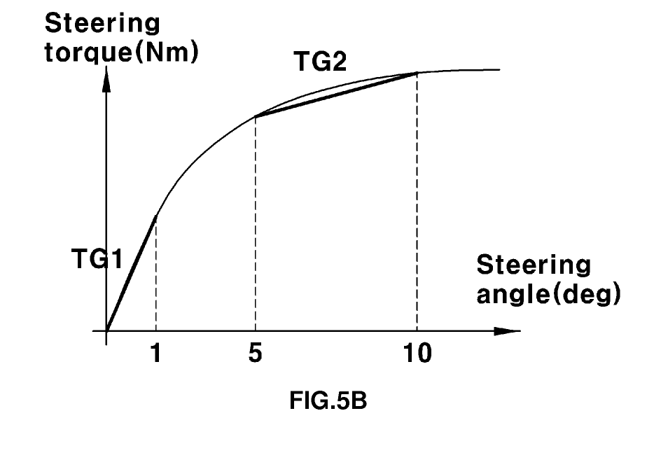

For example, FIGS. 5A and 5B are views showing a performance parameter of an MDPS in the present disclosure. In the MDPS, steering torques T1 and T0 at a specific lateral acceleration, slopes of the steering torque G1 and G0, a ratio of the slopes of the steering torque G1/G0, steering frictional forces defined by the slope of the steering torques at a specific steering angle range TG1/and TG2, a steering force, an on-center stiffness of a steering wheel, an off-center stiffness, an on/off-center linearity G1/G0, and a dead band D1, which are configured by existing evaluation, are derived through performance evaluation of a competing vehicle and analysis of the evaluation result.

Since the steering frictional force (steering feeling) and the steering force mean subjective steering performance, the slopes G1 and G0 mean the subjective stiffness performance.

FIGS. 5A and 5B show performance parameters of the MDPS. Various performance parameters may be derived with respect to an electronic device, wherein a target performance may be set with respect to the respective performance parameters.

Moreover, a target tuning performance of the performance parameters, which influence the steering performance, are set by evaluating the performance of the competing vehicle.

Here, the competing vehicle indicates a vehicle manufactured by other automobile manufacturer for bench-marketing and having a specific target performance.

The target tuning performance may be obtained by quantitatively analyzing performance evaluation of an electronic device and a vehicle having a specific performance, e.g., the competing vehicle, for the respective performance parameters.

For example, in the MDPS, steering performance parameters, which are necessary to establish a quantitative target, are defined by considering subjective performance. Then, the quantitative target performance parameters may be set by a vehicle speed and a steering angular velocity with respect to the respective performance parameters from the evaluation results of the steering feeling of the competing vehicle.

In step S12, a pre-tuning map is established by which an interpretation model of the new vehicle and the device and a control model (a control logic) of the device are established, and dynamics and influence analysis is carried out with respect to the models to set optimal tuning parameters which satisfy the target performance.

During this process, an overall vehicle model and a device model are established using an interpretation program of a computer and a control model controlling the electronic device with inputted parameters is established, and then the dynamics analysis is carried out using these.

In this case, by analyzing influence of the tuning parameters with respect to the device of the vehicle through the dynamics analysis, the optimal tuning parameters with respect to the respective inputted parameters are obtained to establish the pre-tuning map.

The pre-tuning map is established by setting the tuning parameters satisfying the target performance before manufacturing the vehicle, that is, before the actual vehicle tuning and evaluation. A final tuning map is fixed after the actual vehicle tuning and the performance evaluation by carrying out the performance estimation of the pre-tuning map and applying the pre-tuning map undergone the performance estimation to an actual vehicle.

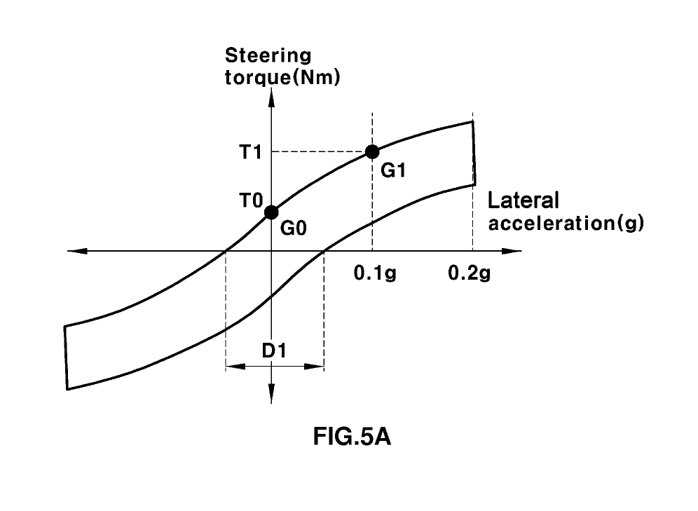

FIG. 4 shows a process of completing the pre-tuning map, after establishment of the target performance, a vehicle model, and a model of a steering system of the vehicle which includes the MDPS for the interpretation are established. An interpretation model and a control model, with which are associated by designing an MDPS control logic, are built through the optimization of the tuning parameters obtaining the optimal tuning parameters which satisfying the target performance using the above-listed models.

For example, the pre-tuning map such as an MDPS control value is set, which is an optimal tuning parameter of an MDPS motor torque (a steering auxiliary torque) or an MDPS motor current by considering at least one of a steering input of a steering wheel, a steering angular velocity, and a vehicle speed as an input parameter. Here, the steering input, which is a torque and a steering angle, occurs when a driver manipulates the steering wheel.

According to the present inventive concept, the tuning map optimizing process sets the optimal tuning parameter satisfying the device performance and the target vehicle performance using the interpretation model to which the properties of a new vehicle are applied. Such a process is carried out to provide the pre-tuning map approaching the final tuning map satisfying the aiming actual vehicle performance and the vehicle performance during the actual vehicle tuning and evaluation process.

Next, in step S13, the performance of the pre-tuning map is estimated in advance using an estimating program including a performance estimating function and estimated data for the performance is provided during the actual vehicle tuning and evaluation with the pre-tuning map.

Step S13 estimates the actual vehicle performance and the vehicle performance when the pre-tuning map is applied to an actual vehicle, and provides a tuning map verified through the initial performance estimation to the pre-tuning map and software including the same, while the estimated data for the performance is used as reference during the actual vehicle tuning and evaluation.

In this case, the pre-tuning map and the early performance estimated data correspond to hardware and an evaluation report for guaranteeing performance of the hardware. The evaluation report is provided during the development of the hardware and the actual vehicle evaluation and may be called an evaluation report of software which guarantees performance of software including the pre-tuning map.

In addition, the initial performance estimation of the pre-tuning map may evaluate the hardware and prepare the evaluation report, before the actual vehicle evaluation.

In the performance estimation of the pre-tuning map, the estimated performance is estimated by applying respective parameters to the performance estimating function of the estimation program. The performance estimation function is expressed by the following equation:

Y=A1X1+A2X2+A3X3+A4X4+ . . . +ANXN+Yu, [Equation 1]

where Y is a performance estimation, A1, A2, A3, A4, AN, and Yu are constants preset by evaluating in advance and analyzing, and X1, X2, X3, X4, and XN are performance parameters.

Here, the performance parameters may be a steering frictional force, a steering force, On/Off-center stiffness and On/Off center linearity of a steering wheel and may be obtained from performance analysis using an interpretation model of a device and a vehicle while the pre-tuning map is applied to the control model (the control logic).

The performance estimation to the pre-tuning map is obtained by obtaining the performance estimation values from the performance estimation function, and the obtained performance estimation data is provided to the actual vehicle tuning and evaluation and used as reference.

The pre-tuning map, in which properties of the new vehicle are applied and the target performance is verified, is obtained. Then, the actual vehicle tuning including a process of a fine tuning is carried out by applying the pre-tuning map to the control logic of the corresponding device in an actual vehicle state where the vehicle device is mounted in the new vehicle (S14).

After the actual vehicle performance is evaluated (S15), if the actual vehicle performance of the vehicle device satisfies the target performance, the tuning map is finalized as final specifications for the mass production (S16 and S17). However, if not, the pre-tuning map is re-built by repeating steps S11 to S13 of establishing the target performance for the pre-tuning map and setting and optimizing the tuning parameters.

If the actual vehicle performance satisfies the target performance throughout the actual vehicle tuning (S14) and the actual vehicle performance evaluation (S15) to the rebuilt pre-tuning map, the final pre-tuning map is finalized.

Since the above-described tuning and actual vehicle performance evaluation are not different from the existing process but the actual vehicle tuning is carried out by applying the pre-tuning map optimized to the new vehicle, the target performance of a vehicle with simple fine tuning may be achieved in the actual vehicle tuning according to the embodiment of the present inventive concept.

Although the present disclosure has been described in detail, the scope of the present invention is not limited to the description but various modifications made by those skilled in the art using the basic concept of the present invention defined by the claims also fall within the scope of the present invention.

What is claimed is:

1. A method of making a tuning map for controlling a vehicle device, comprising:
deriving performance parameters of the vehicle device for a new vehicle and setting a target tuning performance;
establishing a pre-tuning map by building an interpretation model of the new vehicle including an interpretation model and a control model of the vehicle device and setting tuning parameters which satisfy the target tuning performance using the performance parameters through interpretation of the interpretation model of the new vehicle model, the interpretation model of the vehicle device, and the control model for the vehicle device;
applying the pre-tuning map to a control logic of the vehicle device for an actual vehicle which includes the vehicle device mounted therein and performing an actual vehicle tuning; and
evaluating whether an actual vehicle performance satisfy a target performance after tuning the actual vehicle and finalizing the tuning map when the target tuning performance is satisfied,
wherein the tuning map controls the vehicle device, and
wherein in the actual vehicle, the vehicle device is mounted after manufacturing the new vehicle.

2. The method of claim 1, wherein the step of establishing the pre-tuning map and setting the target tuning performance includes:
evaluating a performance and analyzing evaluation results on a manufactured vehicle which has a preset performance to derive the performance parameters of the vehicle device and to set the tuning target performance.

3. The method of claim 1, wherein the vehicle device is a motor driven power steering (MDPS) and the tuning map is an MDPS tuning map for determining a vehicle control value to assist steering by considering at least one of a steering input value and a vehicle speed as an input parameter when a driver manipulates a steering wheel.

4. The method of claim 1, wherein, in the step of establishing the pre-tuning map, the pre-tuning map is established by setting the tuning parameters which satisfy the target tuning performance with respect to an input parameter using an interpretation program analyzing an influence of the tuning parameters of the vehicle device through the dynamics analysis.

5. The method of claim 1, further comprising estimating an initial performance of the pre-tuning map using an estimation program including a performance estimation program after establishing the pre-tuning map and providing performance estimation data with the pre-tuning map to the actual vehicle tuning and evaluation.

6. The method of claim 5, wherein, the initial performance is estimated based on a performance parameter value obtained by performance analysis using the interpretation model of the vehicle device and the new vehicle while the pre-tuning map is applied to the control model by the following equation:
Y=A1X1+A2X2+A3X3+A4X4+ . . . +ANXN+Yu,
where Y is a performance estimation, A1, A2, A3, A4, AN, and Yu are constants preset initially by analyzing previously, and X1, X2, X3, X4, and XN are the performance parameters.
